(19) United States
(12) Patent Application Publication
(10) Pub. No.: US 2026/0075454 A1
(43) Pub. Date: Mar. 12, 2026

(54) INDICATION INFORMATION PROCESSING METHOD AND APPARATUS

(71) Applicant: HONOR DEVICE CO., LTD., Shenzhen (CN)

(72) Inventor: Jian ZHANG, Shenzhen (CN)

(21) Appl. No.: 19/395,119

(22) Filed: Nov. 20, 2025

Related U.S. Application Data
(63) Continuation of application No. PCT/CN2024/082931, filed on Mar. 21, 2024.

(30) Foreign Application Priority Data
Aug. 10, 2023 (CN) 202311010513.6

(51) Int. Cl. H04W 24/10; H04W 24/02; H04W 24/08

(52) U.S. Cl. CPC H04W 24/10; H04W 24/02; H04W 24/08

(57) ABSTRACT

Embodiments of this application provide an indication information processing method and apparatus. The method includes: receiving first signaling sent by a network device; determining a first TO in a plurality of transmission occasions TOs in a first reporting period according to the first signaling, where the plurality of TOs are indicated by at least two sets of configured grant CG configurations; and sending first indication information on the first TO, where the first indication information is used to indicate a TO usage status in the first reporting period. In the technical solution of this application, by using an indication of the first signaling, a TO usage status can still be effectively reported in a scenario of a plurality of CG configurations.

### CROSS-REFERENCE TO RELATED APPLICATIONS

This application is a continuation of International Application No. PCT/CN2024/082931, filed on Mar. 21, 2024, which claims priority to Chinese Patent Application No. 202311010513.6, filed on Aug. 10, 2023, both of which are incorporated herein by reference in their entireties.

### TECHNICAL FIELD

This application relates to the field of communication, and in particular, to an indication information processing method and apparatus.

### BACKGROUND

Semi-persistent scheduling is a scheduling manner in which a transmission resource is periodically preconfigured, and may periodically reserve a CG resource for a terminal device through a CG configuration.

To improve the system capacity, one CG enhancing manner is to split one PUSCH in one CG period into a plurality of PUSCHs for sending, and a PUSCH TO that is not used by a UE is indicated in advance by using reported information. In addition, currently, a network device may send a plurality of sets of CG configurations to the terminal device.

However, for the plurality of sets of CG configurations, currently, there is no effective solution to how to indicate a usage status of the PUSCH TO by using the reported information.

### SUMMARY

Embodiments of this application provide an indication information processing method and apparatus, applied to the field of communication technologies.

According to a first aspect, an embodiment of this application provides an indication information processing method, applied to a terminal device. The method includes:
receiving first signaling sent by a network device;
determining a first TO in a plurality of transmission occasions TOs in a first reporting period according to the first signaling, where the plurality of TOs are indicated by at least two sets of configured grant CG configurations; and
sending first indication information on the first TO, where the first indication information is used to indicate a TO usage status in the first reporting period.

In this implementation, the first TO is determined in the plurality of TOs in the first reporting period according to the indication of the first signaling, so that specific TOs used for reporting information can be determined for the plurality of TOs indicated by the plurality of CG configurations. Then, the first indication information is sent on the determined first TO, thereby effectively reporting a TO usage status in a scenario of the plurality of CG configurations.

In a possible design, the first signaling includes a first field, and the first field is used to indicate a first CG configuration set allowed to send the first indication information.

In this implementation, the first field can be used to effectively indicate a TO of a CG configuration which can be used to send the first indication information. In a possible design, the first signaling further includes a second field, the second field is used to indicate a second CG configuration set, and the first indication information is used to indicate a TO usage status of the second CG configuration set in a reporting period.

In this implementation, the second field can be used to effectively indicate a TO usage status of a CG configuration which is specifically indicated by the first indication information.

In a possible design, the first signaling further includes a third field, and the third field is used to indicate whether physical uplink shared channels PUSCHs are simultaneously sent on a plurality of coinciding TOs.

In this implementation, the third field can be used to effectively indicate a manner of sending PUSCHs when TOs coincide, in a scenario of the plurality of CG configurations.

In a possible design, the first signaling further includes a fourth field, and the fourth field is used TO indicate, when PUSCHs are simultaneously sent on a plurality of coinciding TOs, whether each of the plurality of simultaneously sent PUSCHs carries the first indication information.

In this implementation, the fourth field can be used to effectively indicate a manner of sending the first indication information when the PUSCHs are simultaneously sent on the plurality of coinciding TOs in a scenario of the plurality of CG configurations.

In a possible design, the determining a first TO in a plurality of TOs in a first reporting period according to the first signaling includes:
determining, for any TO in the plurality of TOs, the TO as the first TO if no TO coinciding with the TO exists and a CG configuration corresponding to the TO is included in the first CG configuration set.

In a possible design, the determining a first TO in a plurality of TOs in a first reporting period according to the first signaling includes:
determining, for any TO in the plurality of TOs if another TO coinciding with the TO exists and each of CG configurations respectively corresponding to a plurality of coinciding TOs is included in the first CG configuration set, the first TO in the plurality of coinciding TOs according to the third field.

In a possible design, the determining the first TO in the plurality of coinciding TOs according to the third field includes:
determining, if the third field indicates that PUSCHs are not simultaneously sent on a plurality of coinciding TOs, a TO indicated as a to-be-used TO in the plurality of coinciding TOs as the first TO; or
determining, if the third field indicates that PUSCHs are simultaneously sent on a plurality of coinciding TOs, the first TO in the plurality of coinciding TOs according to the fourth field.

In a possible design, the determining the first TO in the plurality of coinciding TOs according to the fourth field includes:
determining, if the fourth field indicates that each of the plurality of simultaneously sent PUSCHs carries the first indication information, each of the plurality of coinciding TOs as the first TO; or
determining, if the fourth field indicates that none of the plurality of simultaneously sent PUSCHs carries the first indication information, a target TO of the plurality of coinciding TOs as the first TO.

In a possible design, the target TO is a TO corresponding to a predefined CG configuration in the plurality of coinciding TOs.

In a possible design, the predefined CG configuration is a first CG configuration in the first CG configuration set; or
the predefined CG configuration is a CG configuration having a smallest sequence number in the first CG configuration set.

In this implementation, in various possible TO distribution cases caused by existence of the plurality of sets of CG configurations, the first TO used to send the first indication information can be correctly and effectively determined by using each field in the first signaling.

In a possible design, the first indication information includes bits of TOs corresponding to CG configurations in the second CG configuration set in the first reporting period, and the bits are used to indicate whether the terminal device uses the corresponding TOs.

In a possible design, an arrangement order of the bits is: sorting is performed according to a chronological order of the TOs; and then sorting is performed for a plurality of chronologically coinciding TOs according to an order of corresponding CG configurations in the second CG configuration set.

In a possible design, an arrangement order of the bits is: sorting is performed according to an order of the CG configurations in the second CG configuration set; and then sorting is performed for the TOs corresponding to all the CG configurations according to a chronological order of the TOs.

In this implementation, the first indication information can be accurately and sequentially encoded, so that the first indication information can effectively indicate the TO usage status in the first reporting period.

In a possible design, the first signaling is radio resource control RRC signaling.

In a possible design, the first indication information is uplink control information UCI.

According to a second aspect, an embodiment of this application provides an indication information processing method, applied to a network device. The method includes:
sending first signaling to a terminal device;
determining a first TO in a plurality of TOs in a first reporting period according to the first signaling, where the plurality of TOs are indicated by at least two sets of CG configurations; and
receiving first indication information on the first TO, where the first indication information is used to indicate a TO usage status in the first reporting period.

In a possible design, the first signaling includes a first field, and the first field is used to indicate a first CG configuration set allowed to send the first indication information.

In a possible design, the first signaling further includes a second field, the second field is used to indicate a second CG configuration set, and the first indication information is used to indicate a TO usage status of the second CG configuration set in a reporting period.

In a possible design, the first signaling further includes a third field, and the third field is used to indicate whether PUSCHs are simultaneously sent on a plurality of coinciding TOs.

In a possible design, the first signaling further includes a fourth field, and the fourth field is used TO indicate, when PUSCHs are simultaneously sent on a plurality of coinciding TOs, whether each of the plurality of simultaneously sent PUSCHs carries the first indication information.

In a possible design, the determining a first TO in a plurality of TOs in a first reporting period according to the first signaling includes:
determining, for any TO in the plurality of TOs, the TO as the first TO if no TO coinciding with the TO exists and a CG configuration corresponding to the TO is included in the first CG configuration set.

In a possible design, the determining a first TO in a plurality of TOs in a first reporting period according to the first signaling includes:
determining, for any TO in the plurality of TOs if another TO coinciding with the TO exists and each of CG configurations respectively corresponding to a plurality of coinciding TOs is included in the first CG configuration set, the first TO in the plurality of coinciding TOs according to the third field.

In a possible design, the determining the first TO in the plurality of coinciding TOs according to the third field includes:
determining, if the third field indicates that PUSCHs are not simultaneously sent on a plurality of coinciding TOs, a TO indicated as a to-be-used TO in the plurality of coinciding TOs as the first TO; or
determining, if the third field indicates that PUSCHs are simultaneously sent on a plurality of coinciding TOs, the first TO in the plurality of coinciding TOs according to the fourth field.

In a possible design, the determining the first TO in the plurality of coinciding TOs according to the fourth field includes:
determining, if the fourth field indicates that each of the plurality of simultaneously sent PUSCHs carries the first indication information, each of the plurality of coinciding TOs as the first TO; or
determining, if the fourth field indicates that none of the plurality of simultaneously sent PUSCHs carries the first indication information, a target TO of the plurality of coinciding TOs as the first TO.

In a possible design, the target TO is a TO corresponding to a predefined CG configuration in the plurality of coinciding TOs.

In a possible design, the predefined CG configuration is a first CG configuration in the first CG configuration set; or
the predefined CG configuration is a CG configuration having a smallest sequence number in the first CG configuration set.

In a possible design, the first indication information includes bits of TOs corresponding to CG configurations in the second CG configuration set in the first reporting period, and the bits are used to indicate whether the terminal device uses the corresponding TOs.

In a possible design, an arrangement order of the bits is: sorting is performed according to a chronological order of the TOs; and then sorting is performed for a plurality of chronologically coinciding TOs according to an order of corresponding CG configurations in the second CG configuration set.

In a possible design, an arrangement order of the bits is: sorting is performed according to an order of the CG configurations in the second CG configuration set; and then sorting is performed for the TOs corresponding to all the CG configurations according to a chronological order of the TOs.

In a possible design, the first signaling is RRC signaling.

In a possible design, the first indication information is UCI.

According to a third aspect, an embodiment of this application provides an indication information processing apparatus. The apparatus includes:
a receiving module, configured to receive first signaling sent by a network device;
a processing module, configured to determine a first TO in a plurality of transmission occasions TOs in a first reporting period according to the first signaling, where the plurality of TOs are indicated by at least two sets of configured grant CG configurations; and
a sending module, configured to send first indication information on the first TO, where the first indication information is used to indicate a TO usage status in the first reporting period.

According to a fourth aspect, an embodiment of this application provides an indication information processing apparatus. The apparatus includes:
a sending module, configured to send first signaling to a terminal device;
a processing module, configured to determine a first TO in a plurality of TOs in a first reporting period according to the first signaling, where the plurality of TOs are indicated by at least two sets of CG configurations; and
a receiving module, configured to receive first indication information on the first TO, where the first indication information is used to indicate a TO usage status in the first reporting period.

According to a fifth aspect, an embodiment of this application provides a terminal device. The terminal device may also be referred to as a terminal, a user equipment (UE), a mobile station (MS), a mobile terminal (MT), or the like. The terminal device may be a mobile phone, a smart TV, a wearable device, a tablet computer (Pad), a computer having a wireless transceiver function, a virtual reality (VR) terminal device, an augmented reality (AR) terminal device, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, or the like.

The terminal device includes: a processor and a memory, where the memory stores computer-executable instructions; and the processor executes the computer-executable instructions stored in the memory, to enable the terminal device to perform the method according to the first aspect.

According to a sixth aspect, an embodiment of this application provides a network device. The network device may be a base station (Base Transceiver Station, referred to as BTS for short) in a GSM system or a CDMA system, may be a base station (NodeB, referred to as NB for short) in a WCDMA system, may be an evolved base station (evolved NodeB, referred to as eNB for short), an access point (AP), or a relay station in an LTE system, or may be a base station in a 5G system, or the like.

The network device includes: a processor and a memory, where the memory stores computer-executable instructions; and the processor executes the computer-executable instructions stored in the memory, to enable the terminal device to perform the method according to the second aspect.

According to a seventh aspect, an embodiment of this application provides a computer-readable storage medium. The computer-readable storage medium stores a computer program. When the computer program is executed by a processor, the methods according to the first aspect and the second aspect are implemented.

According to an eighth aspect, an embodiment of this application provides a computer program product. The computer program product includes a computer program. When the computer program is run, a computer is enabled to perform the methods according to the first aspect and the second aspect.

According to a ninth aspect, an embodiment of this application provides a chip. The chip includes a processor. The processor is configured to invoke a computer program in a memory to perform the method according to the first aspect and the second aspect.

It should be understood that technical solutions of the second aspect to the fifth aspect of this application correspond to the technical solution of the first aspect of this application, and beneficial effects achieved in the aspects and corresponding feasible implementations are similar. Details are not described.

### BRIEF DESCRIPTION OF DRAWINGS

FIG. 1 is a diagram of a communication scenario according to an embodiment of this application;

FIG. 2 is a diagram of a frame period according to an embodiment of this application;

FIG. 3 is a diagram of PUSCH splitting according to an embodiment of this application;

FIG. 4 is a diagram of CG1 PUSCH splitting according to an embodiment of this application;

FIG. 5 is a diagram of CG2 PUSCH splitting according to an embodiment of this application;

FIG. 6 is a diagram of UTO-UCI reporting according to an embodiment of this application;

FIG. 7 is a diagram of configuring a UTO-UCI reporting period according to an embodiment of this application;

FIG. 8 is a first diagram of a plurality of sets of CG configurations according to an embodiment of this application;

FIG. 9 is a second diagram of a plurality of sets of CG configurations according to an embodiment of this application;

FIG. 10 is a flowchart of an indication information processing method according to an embodiment of this application;

FIG. 11 is a diagram of implementation of determining a first TO according to an embodiment of this application;

FIG. 12 is a first diagram of implementation of determining UTO-UCI according to an embodiment of this application;

FIG. 13 is a second diagram of implementation of determining UTO-UCI according to an embodiment of this application;

FIG. 14 is a first diagram of a structure of an indication information processing apparatus according to an embodiment of this application;

FIG. 15 is a second diagram of a structure of an indication information processing apparatus according to an embodiment of this application;

FIG. 16 is a diagram of a structure of a terminal device according to an embodiment of this application; and

FIG. 17 is a diagram of a structure of a network device according to an embodiment of this application.

### DESCRIPTION OF EMBODIMENTS

For ease of understanding, related concepts in this application are first explained and described.

Terminal device: The terminal device may be a device that has a wireless transceiver function and can cooperate with a network device to provide a communication service for a user. Specifically, the terminal device may be a user equipment (UE), an access terminal, a subscriber unit, a subscriber station, a mobile station, a remote station, a remote terminal, a mobile device, a user terminal, a terminal, a wireless communication device, a user agent, or a user apparatus. For example, the terminal device may be a cellular phone, a cordless telephone, a session initiation protocol (SIP) phone, a wireless local loop (WLL) station, a personal digital assistant (PDA), a handheld device having a wireless communication function, a computing device or another processing device connected to a wireless modem, an on-board device, a wearable device, or a terminal device in a future 5G network or a network after 5G.

Network device: The network device may be a device configured to communicate with a terminal device, for example, may be a base station (BTS) in a global system for mobile communication (GSM) or code division multiple access (CDMA) communication system, or may be a base station (NodeB, NB) in a wideband code division multiple access (WCDMA) system, and may further be an evolved base station (Evolved Node B, eNB or eNodeB) in an LTE system, or the network device may be a relay station, an access point, an on-board device, a wearable device, a network side device in a future 5G network or a network after 5G, a network device in a future evolved public land mobile network (PLMN) network, or the like.

The network device involved in embodiments of this application may also be referred to as a radio access network (RAN) device. The RAN device is connected to the terminal device, and is configured to receive data of the terminal device and send the data to a core network device. The RAN device corresponds to different devices in different communication systems, for example, corresponds to a base station and a base station controller in a 2G system, corresponds to a base station and a radio network controller (RNC) in a 3G system, corresponds to an evolved base station (Evolved Node B, eNB) in a 4G system, and corresponds to a 5G system in a 5G system, for example, an access network device (for example, a gNB, a central unit CU, and a distributed unit DU) in new radio (NR).

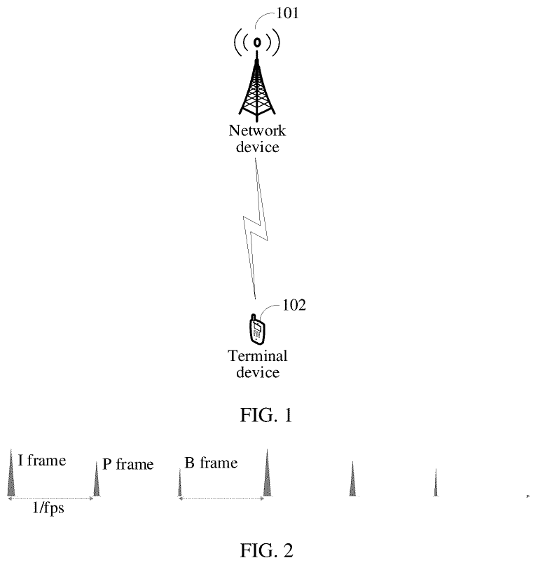

A scenario to which a communication method in this application is applicable is described below with reference to FIG. 1.

FIG. 1 is a diagram of a communication scenario according to an embodiment of this application. Referring to FIG. 1, a network device 101 and a terminal device 102 are included. The network device 101 and the terminal device 102 may perform wireless communication. The terminal device 102 may communicate with at least one core network through a radio access network (Radio Access Network, RAN).

A communication system may be a global system for mobile communication (referred to as GSM for short), a code division multiple access (referred to as CDMA for short) system, a wideband code division multiple access (referred to as WCDMA for short) system, a long term evolution (Long Term XR VR AREvolved, referred to as LTE for short) system, or a fifth generation (5th-Generation, referred to as 5G for short) mobile communication system.

Correspondingly, the network device may be a base station (Base Transceiver Station, referred to as BTS for short) in a GSM system or a CDMA system, or may be a base station (NodeB, referred to as NB for short) in a WCDMA system, may further be an evolved base station (evolved NodeB, referred to as eNB for short), an access point (AP), or a relay station in an LTE system, or may be a base station in a 5G system, or the like. This is not limited herein.

The 5G mobile communication system in this application includes a non-standalone (NSA) 5G mobile communication system and/or a standalone (SA) 5G mobile communication system. Technical solutions provided in this application are also applicable to a future communication system, for example, a sixth mobile communication system. The communication system may alternatively be a PLMN network, a device-to-device (D2D) network, a machine to machine (M2M) network, an IoT network, or another network.

It may be understood that, if the technical solutions in embodiments of this application are applied to another wireless communication network, a corresponding name may be replaced with a name of a corresponding function in the another wireless communication network.

A network architecture and a service scenario described in embodiments of this application are intended to describe the technical solutions in embodiments of this application more clearly, and do not constitute a limitation on the technical solutions provided in embodiments of this application. A person of ordinary skill in the art may learn that with evolution of the network architecture and emergence of new service scenarios, the technical solutions provided in embodiments of this application are also applicable to similar technical problems.

The development of 5G technologies also drives progress of extended reality (XR) services such as a virtual reality (VR) service, an augmented reality (AR) service, and a mixed reality (MR) service.

A scenario of the VR service is used as an example. In a virtual reality (VR) scenario, a frame has period. A frame transmission period may be understood with reference to FIG. 2. FIG. 2 is a diagram of a frame period according to an embodiment of this application.

As shown in FIG. 2, in a VR scenario, uplink transmission of a video frame may be performed once at an interval of a fixed period. The transmitted video frame may be, for example, an I frame (a key frame), a P frame (a forward reference frame), or a B frame (a bidirectional reference frame).

It may be determined with reference to FIG. 2 that, a frame transmission period is 1/fps, where fps is a quantity of transmitted frames per second (Frames Per Second). For example, if fps is 30, a corresponding frame transmission period is 33.33 ms. For another example, if fps is 60, a corresponding frame transmission period is 16.67 ms. For another example, if fps is 120, a corresponding frame transmission period is 8.33 ms.

Currently, dynamic scheduling or semi-persistent scheduling may be used for uplink transmission.

For the dynamic scheduling, a network device needs to send DCI (downlink control information) to a terminal device to configure an uplink resource, and then the terminal device sends a PUSCH (physical uplink shared channel) on the corresponding uplink resource.

However, for an XR service whose uplink data needs to be periodically sent, if the dynamic scheduling is used, the network device needs to send DCI a plurality of times. In addition, the XR service has a high requirement on a delay, and a plurality of signaling interactions in a dynamic scheduling process may also affect the delay.

The semi-persistent scheduling is a scheduling manner in which a transmission resource is periodically preconfigured. Therefore, the semi-persistent scheduling is most suitable for an XR service of a periodic type in terms of power consumption and a delay.

In the uplink transmission, there are the following two types of scheduling solutions without a dynamic grant, and a main difference lies in different activation manners.

Type 1 (Configured Grant type 1, CG1): In this solution, RRC (radio resource control) signaling is used for configuring all parameters and activating the uplink transmission. The UE may send a PUSCH on a configured periodic uplink resource without activation by using the DCI, provided that an RRC configuration succeeds.

Type 2 (Configured Grant type 2, CG2): In this solution, the network device first configures a data transmission period for the UE by using RRC signaling, then activates or releases an uplink CG by using a PDCCH (physical downlink control channel) scrambled by using a CS-RNTI (configured scheduling radio network temporary identifier), and specifies a radio resource used by the uplink CG. Then, in each period, the UE may use a CG resource to send a PUSCH.

By using the CG, periodic sending can be implemented without dynamic scheduling each time, which is suitable for a feature of the XR service. However, in the XR service, especially for a scenario like MR, service data of a video type needs to be sent in the uplink transmission, and the service data has large data volume and occupies many resources. If a CG resource in a period is reserved for each UE based on maximum traffic volume of a single transmission, system capacity is very limited. For example, in an XR scenario, a system can support only approximately 10 UEs.

In this case, to improve the system capacity, the CG may be enhanced in the following two aspects.

In the first aspect, one PUSCH in a CG period is split into a plurality of PUSCHs for sending.

In the second aspect, the UE may dynamically indicate a specific unused PUSCH in the CG period.

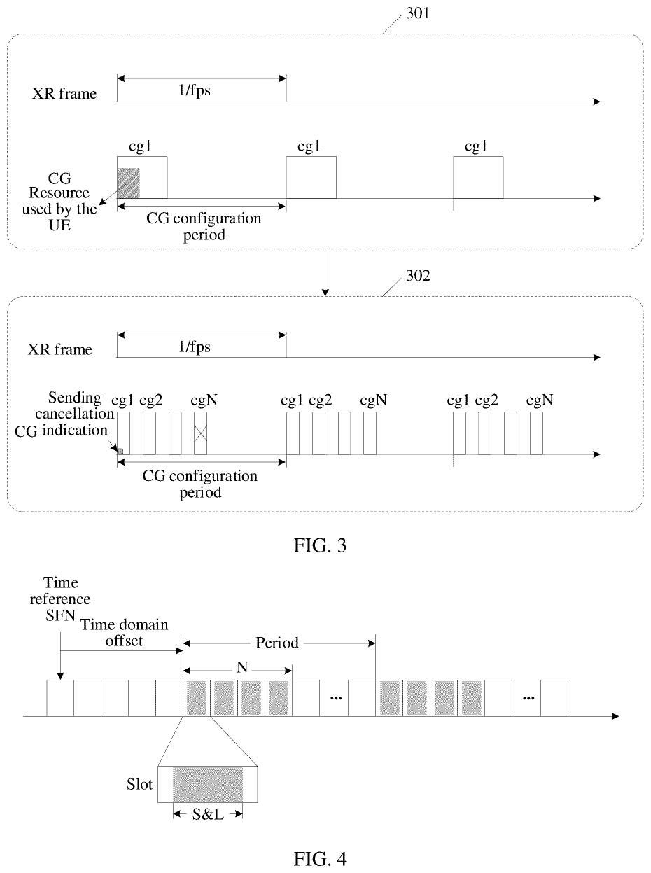

For example, understanding may be performed with reference to FIG. 3. FIG. 3 is a diagram of PUSCH splitting according to an embodiment of this application.

In FIG. 3, 301 shows a case in which a CG resource in a period is reserved for a UE based on maximum traffic volume of a single transmission. It may be understood with reference to 301 that, in each CG configuration period, a same CG resource is reserved by using the maximum traffic volume as a standard.

A first CG configuration period is used as an example. A network device reserves a large quantity of CG resources for the terminal device. However, assuming that the UE performs uplink data transmission only on a CG resource shown in the gray part, a reserved CG resource outside the gray part is wasted.

Further refer to 302 in FIG. 3. One PUSCH in a CG period may be split into a plurality of PUSCHs for sending. For example, by comparing 301 and 302, it may be understood that actually, quantities of CG resources reserved in the CG period are the same. However, in 302, each CG configuration period includes a plurality of CG resources with a small resource quantity, and each CG resource is used for transmission of one PUSCH.

In addition, assuming that a PUSCH sent on a CG resource 1 in the first configuration period may carry a sending cancellation indication, and the sending cancellation indication is used for indicating that the current UE does not use a 4th CG resource, the network device may allocate the CG resource 4 to another UE for use.

In other words, through splitting and advance indication, the network device may dynamically allocate sending resources of some PUSCHs that are not used by a UE in a CG period to another UE for use, so that system capacity is improved.

For the example in FIG. 3, it should be further noted that, in FIG. 3, the CG configuration period and a frame transmission period of an XR service are consistent. In an actual implementation process, the CG configuration period may alternatively be inconsistent with the frame transmission period of the XR service. This is not limited in this application.

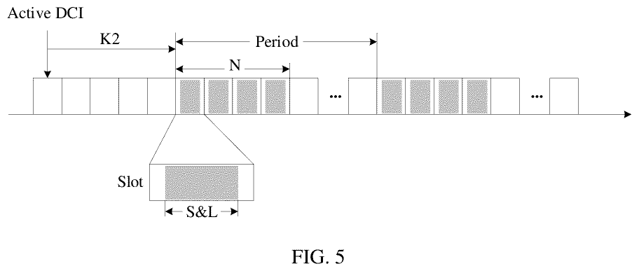

The following further describes, with reference to FIG. 4 and FIG. 5, cases of PUSCH splitting respectively corresponding to the foregoing two CG types. FIG. 4 is a diagram of CG1 PUSCH splitting according to an embodiment of this application. FIG. 5 is a diagram of CG2 PUSCH splitting according to an embodiment of this application.

In FIG. 4 and FIG. 5, one small white grid represents one slot (slot), and a gray filled part in a small white grid represents a CG resource.

Refer to FIG. 4. For the CG1, a time reference SFN and a time domain offset are used for indicating a start position of a CG resource. In addition, each CG configuration period includes N CG resources, where the N CG resources are resources at specified positions in N available slots (slots). For example, RRC may configure an S&L (start symbol & symbol length, start symbol & symbol length), so that the resources at the specified positions in the available slots may all be resources indicated by the S&L.

In addition, refer to FIG. 5. For the CG2, active DCI and a slot offset (K2) are used for indicating a start position of a CG resource. In addition, each CG configuration period includes N CG resources, where the N CG resources are similar to those described in FIG. 4. A difference lies in that in the CG2, an S&L may be indicated by the active DCI, and the K2 is also indicated by the DCI.

The foregoing describes, with reference to FIG. 4 and FIG. 5, the cases of the PUSCH splitting respectively corresponding to the foregoing two CG types. It may be further determined with reference to the foregoing descriptions that currently, an enhancement in the second aspect further exists. To be specific, a UE may dynamically indicate an unused PUSCH in a period.

A time domain position corresponding to a PUSCH may also be understood as a PUSCH TO (transmission occasion). In this case, for example, newly-defined UCI (uplink control information) may be used for indicating an unused PUSCH in a period. The newly-defined UCI may be UTO-UCI, and a UTO is an unused CG PUSCH Transmission Occasion. The UTO-UCI may be sent a plurality of times in one CG period, for example, sent in a plurality of PUSCHs in one period.

If previously sent UTO-UCI indicates that a PUSCH TO is unused (not used or not sent), the PUSCH TO cannot be modified to be NOT unused (used or sent) later by sending UTO-UCI. For example, 1 indicates unused, and 0 indicates NOT unused. In this case, if the previously sent UTO-UCI indicates that a sending status of a PUSCH TO is 1, the sending status of the occasion cannot be changed to 0 later.

However, if the previously sent UTO-UCI indicates that a PUSCH TO is NOT unused (used or sent), the PUSCH TO nay be modified to be unused (not used or not sent) later by sending UTO-UCI. In other words, if the previously sent UTO-UCI indicates that a sending status of a PUSCH TO is 0, the sending status of the occasion may be modified to 1 later.

Simply, for a PUSCH TO indicated by the UE as NOT unused, the UE actually may send a PUSCH or may not send a PUSCH on the TO. When determining not to send a PUSCH, the UE may indicate again by sending UTO-UCI in advance (namely, a case in which 0 is changed to 1). However, for a PUSCH TO indicated by the UE as unused, the UE cannot regret as long as the UE sends the indication, in other words, the UE cannot indicate again by sending updated UTO-UCI (in other words, 1 cannot be changed to 0).

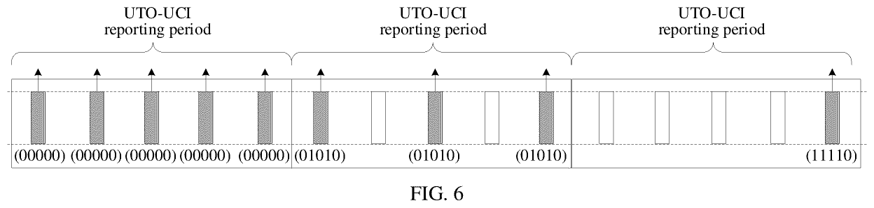

For example, an indication of UTO-UCI may be understood with reference to FIG. 6. FIG. 6 is a diagram of UTO-UCI reporting according to an embodiment of this application.

As shown in FIG. 6, a UTO-UCI reporting period may be configured. The UTO-UCI reporting period may be consistent with or may not be consistent with the foregoing CG configuration period. This is not limited in this application.

For example, it is assumed that in the current example, each UTO-UCI reporting period includes 5 PUSCHs, and it is assumed that a UE carries UTO-UCI in each sent PUSCH.

Refer to FIG. 6. For a first UTO-UCI reporting period, if the 5 PUSCHs in the UTO-UCI reporting period are all to be used by the UE, the UTO-UCI may be configured as 00000 (where 0 indicates to-be-used, and 1 indicates not to-be-used).

In addition, for a second UTO-UCI reporting period, if a 1^{st}, 3^{rd}, and 5^{th} PUSCHs in the UTO-UCI reporting period are to be used by the UE, and a 2^{nd} and 4^{th} PUSCHs in a CG period are not to be used by the UE, the UTO-UCI may be configured as 01010. In addition, because the 2^{nd} PUSCH and the 4^{th} PUSCH in the CG period are not to be used by the UE, the UE naturally does not send the two PUSCHs. In this way, UTO-UCI is correspondingly not transmitted on the two PUSCH TOs.

For a case in the second UTO-UCI reporting period, if the UE has transmitted the UTO-UCI on the 1^{st} PUSCH to indicate that the 2^{nd} PUSCH and the 4^{th} PUSCH in the CG period are not to be used, the UE cannot indicate, by using updated UTO-UCI, that the 2^{nd} PUSCH and the 4^{th} PUSCH in the CG period need to be used.

However, although the UE has transmitted the UTO-UCI on the 1^{st} PUSCH to indicate that the 1^{st}, 3^{rd}, and 5^{th} PUSCHs need to be used, if the UE subsequently determines that the UE does not use the 5^{th} PUSCH either, the UE may send updated UTO-UCI on the 3^{rd} PUSCH to indicate that the 5^{th} PUSCH is not to be used.

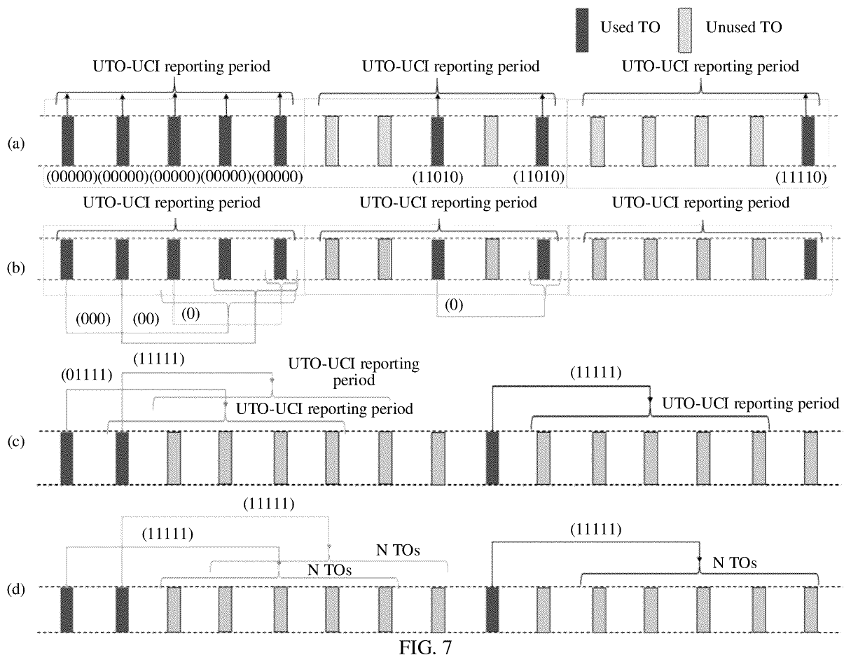

In addition, there are also a plurality of possible implementations for configuring a UTO-UCI reporting period. The plurality of possible implementations of a UTO-UCI reporting period are separately described below with reference to FIG. 7. FIG. 7 is a diagram of configuring a UTO-UCI reporting period according to an embodiment of this application.

With reference to (a) of FIG. 7, in a possible implementation, a UTO-UCI reporting period may be consistent with a CG period. In addition, within a UTO-UCI reporting period, UTO-UCI sent on TOs is the same, and includes usage statuses of all the TOs within the current UTO-UCI reporting period.

For example, a first UTO-UCI reporting period in (a) of FIG. 7 includes five TOs, and all of the five TOs are used TOs. Therefore, UTO-UCI is sent on each of the five TOs, and the UTO-UCI sent on each TO indicates 00000.

With reference to (b) of FIG. 7, in another possible implementation, a UTO-UCI reporting period may be consistent with a CG period. However, within a UTO-UCI reporting period, bits of UTO-UCI sent on TOs vary, and the UTO-UCI includes usage statuses of a start TO indicated by UTO_offset (offset) to a last TO in the current UTO-UCI reporting period.

Using an example in which UTO_offset=1, for example, a first UTO-UCI reporting period in (b) of FIG. 7 includes five TOs, and all of the five TOs are used TOs. If UTO-UCI sent on the 1^{st} TO thereof includes usage statuses of a start TO (that is, the 3^{rd} TO) indicated by UTO_offset=1 to a last TO (that is, the 5^{th} TO) in the current UTO-UCI reporting period, the UTO-UCI sent on the 1^{st} TO indicates 000. The remaining TOs are deduced by analogy. Details are not described herein again.

With reference to (c) of FIG. 7, in another possible implementation, a length of a UTO-UCI reporting period is fixed, for example, is the same as a length of a CG period, but a position of the UTO-UCI reporting period is determined by using a sliding window. For example, a UTO-UCI reporting period may be determined for each used TO. Specifically, a TO that is offset from the used TO by UTO_offset is used as a start TO, and then the UTO-UCI reporting period is determined by using a fixed length from the start TO.

Using an example in which UTO_offset-0, for example, a first TO in (c) of FIG. 7 is a used TO, a TO (that is, 2^{nd} TO) that is offset from the first TO by 0 is used as a start TO, and then a UTO-UCI reporting period is determined by using a fixed length from the start TO. Therefore, the UTO-UCI reporting period determined for the first TO includes the 2^{nd} to the 6th TOs in (c) of FIG. 7, and then, UTO-UCI sent on the first TO indicates a TO usage status in the UTO-UCI reporting period. With reference to (c) of FIG. 7, the UTO-UCI sent on the 1^{st} TO indicates 01111.

The foregoing describes an implementation in which the length of the UTO-UCI reporting period is fixed. When the UTO-UCI reporting period has a fixed length, the quantity of TOs in the UTO-UCI reporting period is not fixed. Therefore, another implementation further exists, and a period length of a UTO may not be fixed.

With reference to (d) of FIG. 7, in another possible implementation, a length of a UTO-UCI reporting period is not fixed. For example, N TOs may be set to be included in each UTO-UCI reporting period, where Nis an integer greater than or equal to 1, so that the quantity of TOs in the UTO-UCI reporting period is fixed. In addition, the position of the UTO-UCI reporting period is determined by using a sliding window, and an implementation of the sliding window is similar to that in (c) of FIG. 7.

It may be determined based on the foregoing content that, for CG enhancement in two aspects, a PUSCH may be split in a CG period, and then, UTO-UCI is reported in the CG period according to a policy. However, currently, the network device may further send a plurality of sets of CG configurations to the terminal device. For the plurality of sets of CG configurations, assuming that UTO-UCI needs to be reported after the PUSCH is split, currently, there is no effective technical solution to whether to support reporting of UTO-UCI by a UE based on the plurality of sets of CG configurations, and how to specifically report UTO-UCI based on the plurality of sets of CG configurations if the reporting is supported.

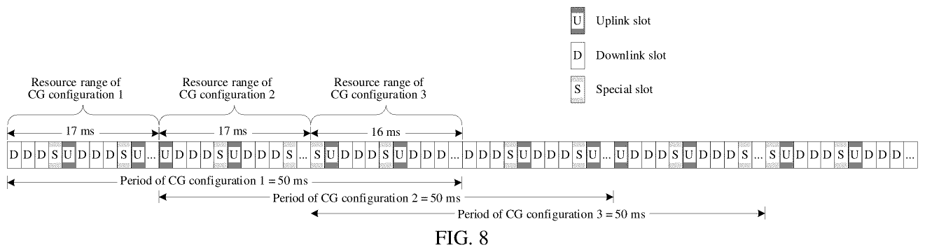

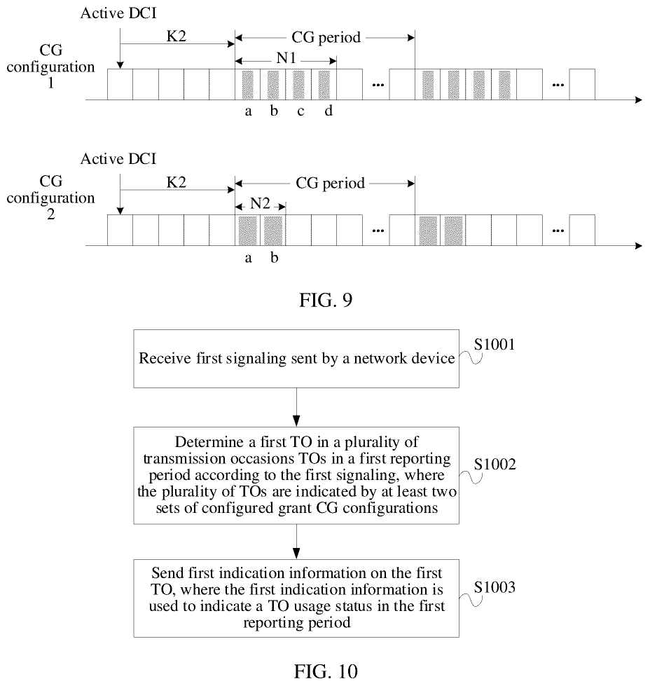

Two possible cases of a plurality of sets of CG configurations are described below with reference to FIG. 8 and FIG. 9 respectively. FIG. 8 is a first diagram of a plurality of sets of CG configurations according to an embodiment of this application, and FIG. 9 is a second diagram of a plurality of sets of CG configurations according to an embodiment of this application.

As shown in FIG. 8, it is assumed that currently there are three sets of CG configurations, which are a CG configuration 1, a CG configuration 2, and a CG configuration 3 respectively, and it is assumed that periods of the three sets of CG configurations are all 50 ms.

In addition, it is assumed that an arrangement manner of slots is repeated by using a period of 50 ms. Multiple slots included in each 50 ms specifically include a plurality of uplink slots (U), a plurality of downlink slots (D), and a plurality of special slots (S, special). Then, it may be determined with reference to FIG. 8 that, for a 50-ms slot structure, the CG configuration 1 includes a PUSCH TO in the first 17 ms, the CG configuration 2 includes a PUSCH TO in the middle 17 ms, the CG configuration 3 includes a PUSCH TO in the last 16 ms, and periodic repetition is performed in sequence. Then, it may be determined with reference to FIG. 8 that, TOs indicated by the three CG configurations do not coincide.

For example, different CG configurations (Config) correspond TO different frame types (an I frame, a P frame, and a B frame), and period alignment is implemented, so that the plurality of CG configurations may be performed with reference TO an implementation in which TO coinciding does not exist and that is described in FIG. 8.

Alternatively, with reference to FIG. 9, it is assumed that a CG configuration 1 and a CG configuration 2 currently exist. The CG configuration 1 and the CG configuration 2 have respective corresponding active DCI and slot offsets K2, which are used to indicate resource start positions respectively corresponding to the two CG configurations.

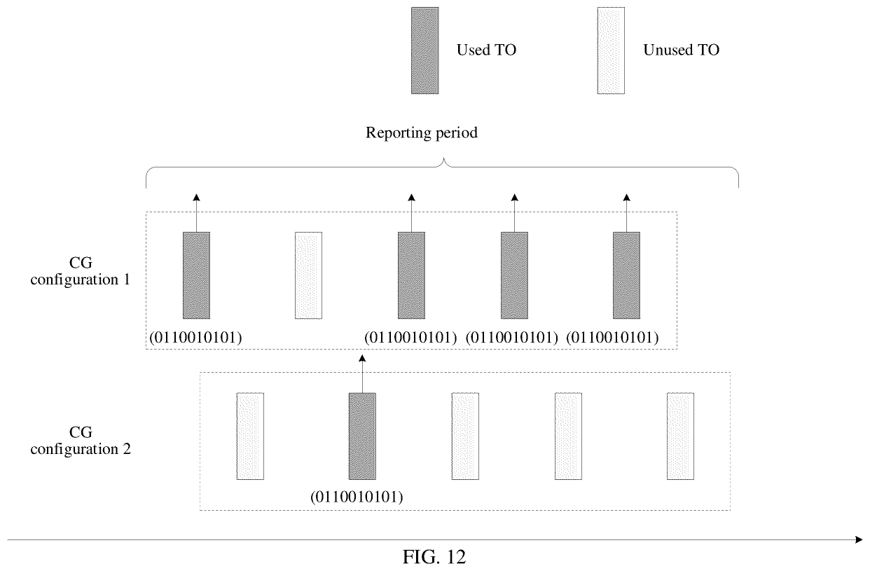

For the CG configuration 1, N1 CG resources are included within each CG configuration period; and for the CG configuration 2, N2 CG resources are included in each CG configuration period. In an example of FIG. 12, assuming that in the first CG period of the CG configuration 1, CG resources exist in a slot a, a slot b, a slot c, and a slot d, and in the first CG period of the CG configuration 2, CG resources exist in both the slot a and the slot b, it may be determined that, TOs respectively corresponding to the CG configuration 1 and the CG configuration 2 coincide.

For example, different CG configurations correspond TO different uplink streams such as a video stream and a posture stream, so that the plurality of CG configurations may be performed with reference TO an implementation in which TO coinciding exists and that is described in FIG. 9.

Based on the foregoing description content, a specific implementation of how to report UTO-UCI for a scenario of a plurality of CG configurations in the indication information processing method provided in this application is described with reference to a specific embodiment.

A description is provided first with reference to FIG. 10. FIG. 10 is a flowchart of an indication information processing method according to an embodiment of this application.

As shown in FIG. 10, the method includes:

S1001: Receive first signaling sent by a network device.

In this embodiment, the network device may send the first signaling to a terminal device. The first signaling may include related indication information for reporting UTO-UCI for a plurality of CG configurations. Therefore, the terminal device may receive the first signaling sent by the network device, and then determine, according to the first signaling, how to send UTO-UCI. The first signaling may be, for example, RRC signaling.

S1002: Determine a first TO in a plurality of transmission occasions TOs in a first reporting period according to the first signaling, where the plurality of TOs are indicated by at least two sets of configured grant CG configurations.

In this embodiment, the terminal device reports a TO usage status by using a reporting period as a unit. That is, the terminal device sends the TO usage status within the reporting period to the network device, so that the network device determines whether the terminal device needs to use each TO within the reporting period. The reporting period may be, for example, the foregoing UTO-UCI reporting period. In addition, for a specific configuration manner of the reporting period, refer to any configuration manner described in the foregoing embodiment of FIG. 7. This is not limited in this embodiment.

Because processing manners in reporting periods are similar, any first reporting period is used as an example for description herein. Assuming that a plurality of TOs is included in the first reporting period, in this embodiment, the plurality of TOs in the first reporting period is indicated by at least two sets of CG configurations.

Understanding may be performed with reference to an example herein. For example, the first reporting period includes four TOs, which are respectively TO1, TO2, TO3, and TO4, and it is assumed that the network device sends two sets of CG configurations to the terminal device, which are respectively a CG configuration 1 and a CG configuration 2. For example, TO1 and TO3 in the first reporting period are TOs indicated by the CG configuration 1, and TO2 and TO4 in the first reporting period are TOs indicated by the CG configuration 2.

That is, in a scenario of this embodiment, the network device sends a plurality of sets of CG configurations to the terminal device, and correspondingly, the first reporting period of the terminal device includes a plurality of TOs indicated by the plurality of sets of CG configurations. Therefore, when a TO usage status is reported, a problem that needs to be resolved is to determine one or more specific TOs on which reporting is performed for the plurality of TOs included in the first reporting period.

Therefore, in this embodiment, the first TO may be determined in the plurality of TOs in the first reporting period according to the first signaling. The first TO is a TO used for reporting a TO usage status. There may be a plurality of first TOs.

S1003: Send first indication information on the first TO, where the first indication information is used to indicate a TO usage status in the first reporting period.

After the first TO is determined, the first indication information may be sent on the first TO. The first indication information in this embodiment is used to indicate a TO usage status in the first reporting period.

For example, the first indication information may be the UTO-UCI described above, or the first indication information may be any type of UCI, or the first indication information may be newly defined indication information, provided that the first indication information can implement a corresponding indication function. In addition, in this embodiment, that the first indication information is sent together with the PUSCH in the first TO may also be understood as that the PUSCH carries the first indication information.

The indication information processing method provided in this embodiment of this application includes: receiving first signaling sent by a network device; determining a first TO in a plurality of transmission occasions TOs in a first reporting period according to the first signaling, where the plurality of TOs are indicated by at least two sets of configured grant CG configurations; and sending first indication information on the first TO, where the first indication information is used to indicate a TO usage status in the first reporting period. The first TO is determined in the plurality of TOs in the first reporting period according to the first signaling, so that specific TOs used for reporting information can be determined for the plurality of TOs indicated by the plurality of CG configurations. Then, the first indication information is sent on the determined first TO, thereby effectively reporting a TO usage status in a scenario of the plurality of CG configurations.

Based on the foregoing description content, the following further subdivides a problem of reporting UTO-UCI in a plurality of CG configurations. Actually, when UTO-UCI is reported in a plurality of CG configurations, problems in the following three aspects mainly need to be resolved:

Problem 1: Determine a CG configuration whose TO can be used for sending the UTO-UCI.

Problem 2: Determine a CG configuration whose TO usage status is indicated by the sent UTO-UCI.

Problem 3: How to encode the sent UTO-UCI for usage statuses of a plurality of TOs within a period.

For the problem 1 and the problem 2 of the problems, configuration may be performed by using a related field in the first signaling. The following further describes an implementation of content included in the first signaling.

In a possible implementation, the first indication information may include a first field, and the first field is used to indicate a first CG configuration set allowed to send the first indication information.

It may be understood that, the network device sends a plurality of sets of CG configurations to the terminal device. The first field indicates, in the plurality of sets of CG configurations, CG configurations which can be used to send the first indication information.

It is assumed that the network device currently sends 4 sets of CG configurations to the terminal device, which are respectively a CG configuration 1, a CG configuration 2, a CG configuration 3, and a CG configuration 4. In addition, it is assumed that the first field is reportCgConfigIndex. If reportCgConfigIndex is configured as {cg1, cg2}, that is, the first CG configuration set includes the CG configuration 1 and the CG configuration 2. That is to say, only TOs of the CG configuration 1 and the CG configuration 2 can be used to send the first indication information.

For example, a CG having few resources is not suitable for sending the first indication information. Therefore, specific CG configurations which may be used to send the first indication information may be indicated by using the first field. In this way, the problem 1 described above is correspondingly resolved. Therefore, in this embodiment, the first field can be used to effectively indicate a TO of a CG configuration which can be used to send the first indication information.

In another possible implementation, the first indication information further includes a second field, the second field is used to indicate a second CG configuration set, and the first indication information is used to indicate a TO usage status of each CG configuration in the second CG configuration set in a reporting period.

It may be understood that, the network device sends a plurality of sets of CG configurations to the terminal device. The second field indicates, in the plurality of sets of CG configurations, CG configurations whose TO usage statuses that the UE specifically needs to report.

It is assumed that the network device currently sends 4 sets of CG configurations to the terminal device, which are respectively a CG configuration 1, a CG configuration 2, a CG configuration 3, and a CG configuration 4. In addition, it is assumed that the second field is targetCgConfigIndex. If targetCgConfigIndex is configured as {cg1, cg2, cg3}, that is, the second CG configuration set includes the CG configuration 1, the CG configuration 2, and the CG configuration 3. That is to say, the UE reports TO usage statuses of the CG configuration 1, the CG configuration 2, and the CG configuration 3.

Therefore, the second field may be used to indicate CG configurations whose TO usage statuses that the UE specifically reports. In this way, the problem 2 described above is correspondingly resolved. Therefore, in this embodiment, the second field can be used to effectively indicate a TO usage status of a CG configuration which is specifically indicated by the first indication information.

In addition, when there is a plurality of sets of CG configurations, TOs indicated by different CG configurations may coincide (which may also be referred to as completely overlap). Therefore, how to handle the coinciding TOs also needs to be correspondingly indicated.

Therefore, the first signaling may further include a third field, and the third field is used to indicate whether PUSCHs are simultaneously sent on a plurality of coinciding TOs.

For example, the third field is simultaneousPusch, and may be an enumerated value ENUMERATED {true}. That is, when the third field is configured as true, it indicates that PUSCHs may be simultaneously sent on a plurality of coinciding TOs. For example, PUSCHs cannot be simultaneously sent on a plurality of coinciding TOs by default. Therefore, when the third field is not configured, it may indicate that PUSCHs cannot be simultaneously sent. Alternatively, when the third field is configured as false, it indicates that PUSCHs cannot be simultaneously sent.

Therefore, in this embodiment, the third field can be used to effectively indicate a manner of sending PUSCHs when TOs coincide, in a scenario of the plurality of CG configurations.

Moreover, for coinciding TOs, if the third field indicates that PUSCHs can be simultaneously sent on the coinciding TOs, whether each of a plurality of simultaneously sent PUSCHs needs to carry UTO-UCI also needs to be correspondingly indicated.

Therefore, the first signaling may further include a fourth field, and the fourth field is used TO indicate, when PUSCHs are simultaneously sent on a plurality of coinciding TOs, whether each of the plurality of simultaneously sent PUSCHs carries the first indication information.

For example, the fourth field is simultaneousReport, and may be an enumerated value ENUMERATED {true}. That is, when the fourth field is configured as true, it indicates that each of a plurality of simultaneously sent PUSCHs carries the first indication information. For example, none of the plurality of simultaneously sent PUSCHs can carry the first indication information. Therefore, when the fourth field is not configured, it may indicate that none of the plurality of simultaneously sent PUSCHs can carry the first indication information. Alternatively, when the fourth field is configured as false, it indicates that none of the plurality of simultaneously sent PUSCHs can carry the first indication information.

Therefore, in this embodiment, the fourth field can be used to effectively indicate a manner of sending the first indication information when the PUSCHs are simultaneously sent on the plurality of coinciding TOs in a scenario of the plurality of CG configurations.

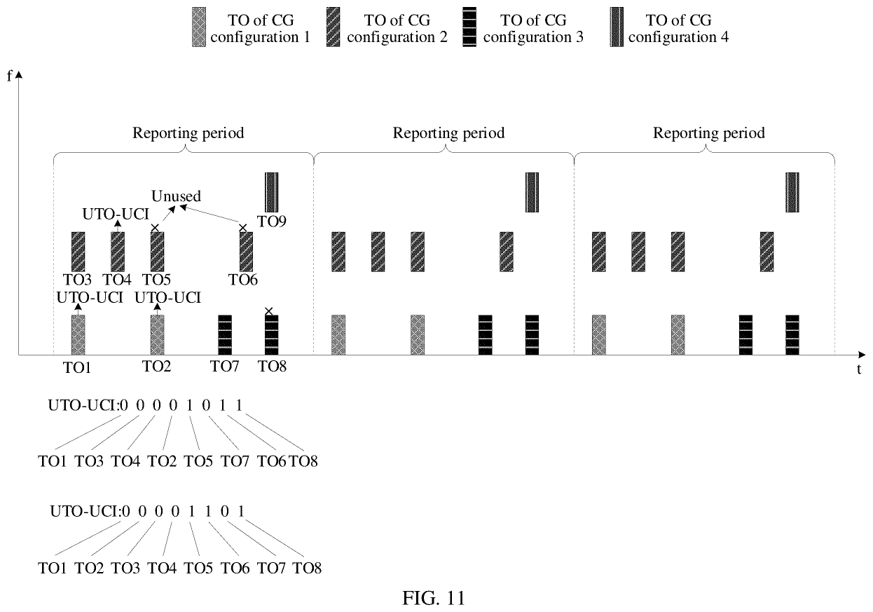

Based on the foregoing fields in the first signaling, a plurality of cases of determining a first TO are separately described below by using a specific example with reference to FIG. 11. FIG. 11 is a diagram of implementation of determining a first TO according to an embodiment of this application.

As shown in FIG. 11, it is assumed that a network device sends 4 sets of CG configurations to a terminal device, which are respectively a CG configuration 1, a CG configuration 2, a CG configuration 3, and a CG configuration 4.

In addition, in FIG. 11, a transverse axis t represents a time domain, and a longitudinal axis f represents a frequency domain. Then, it may be determined with reference to FIG. 11 that, each set of CG configuration indicates corresponding TOs at different time-frequency positions.

In addition, the UE determines a reporting period in a particular manner, where for a specific determining manner, refer to the description in the foregoing embodiment; and then reports a TO usage status within the reporting period. In an example of FIG. 11, it is assumed that each reporting period includes nine TOs. Using the 1^{st} reporting period in FIG. 11 as an example, the nine TOs are respectively two TOs (TO1 and TO2) indicated by the CG configuration 1, four TOs (TO3, TO4, TO5, and TO6) indicated by the CG configuration 2, two TOs (TO7 and TO8) indicated by the CG configuration 3, and one TO (TO9) indicated by the CG configuration 4.

Then, the UE needs to determine, in the nine TOs included in the reporting period, specific TOs on which the first indication information needs to be sent, that is, specific TOs which are first TOs.

Any reporting period in FIG. 11 may be understood as the first reporting period described in the foregoing embodiment. By using the 1^{st} first reporting period as an example, the following describes an implementation of determining the first TO in the period.

For example, the UE determines each TO in the first reporting period. Therefore, the following uses any TO in a plurality of TOs in the first reporting period as an example to describe an implementation of determining whether the TO is the first TO.

Case 1: Determine, for any TO in the plurality of TOs, the TO as the first TO if no TO coinciding with the TO exists and a CG configuration corresponding to the TO is included in the first CG configuration set.

Refer to FIG. 11. for example, for TO4 thereof, currently, there is no other TO that coincides with TO4, and a CG configuration corresponding to TO4 is the CG configuration 2. It is assumed that the first CG configuration set indicated by the first field is {cg1, cg2}, that is, a CG configuration corresponding to TO4 is included in the first CG configuration set. Therefore, it can be confirmed that TO4 is the first TO.

In addition, for another contrary case, referring to FIG. 11, for example, for TO7 thereof, currently, there is no other TO that coincides with TO7, but a CG configuration corresponding to TO7 is the CG configuration 3. It is assumed that the first CG configuration set indicated by the first field is {cg1, cg2}, that is, a CG configuration corresponding to TO7 is not included in the first CG configuration set. Therefore, it can be confirmed that TO7 is not the first TO. That is to say, TO7 cannot be used for sending the first indication information.

Therefore, it can be confirmed that when TOs do not coincide, whether one TO can be used to send the first indication information depends on an indication of the first field.

Case 2: Determine, for any TO in the plurality of TOs if another TO coinciding with the TO exists and each of CG configurations respectively corresponding to a plurality of coinciding TOs is included in the first CG configuration set and if the third field indicates that PUSCHs are not simultaneously sent on a plurality of coinciding TOs, a TO indicated as a to-be-used TO in the plurality of coinciding TOs as the first TO.

Refer to FIG. 11. for example, for TO2 thereof, currently, there is another TO (that is, TO5) that coincides with TO2, a CG configuration corresponding to TO2 is the CG configuration 1, a CG configuration corresponding to TO5 is the CG configuration 2, and the two CG configurations are both included in the first CG configuration set. Therefore, it first indicates that such two TOs as TO2 and TO5 are both qualified to send the first indication information.

However, when TOs coincide, further refer to an indication of the third field. If the third field indicates that PUSCHs are not simultaneously sent on a plurality of coinciding TOs, that is, PUSCHs cannot be simultaneously sent on TO2 and TO5, it indicates that only one TO of the two coinciding TOs can actually send the first indication information.

Moreover, when the PUSCHs cannot be simultaneously sent on the coinciding TOs, it indicates that there is a TO that is not used by the UE in the plurality of coinciding TOs. For example, the previously sent UTO-UCI has been used to indicate that a TO in the plurality of coinciding TOs is used and other TOs are unused. Therefore, the TO that is in the plurality of coinciding TOs and that is indicated by the previous UTO-UCI as used may be determined as the first TO.

Refer to FIG. 11. in the current example, assuming that the UE already indicates, by using the previously sent UTO-UCI, that TO5 is unused and TO2 is used, TO2 may be determined as the first TO, that is, TO2 is used for sending the first indication information.

Case 3: Determine, for any TO in the plurality of TOs if another TO coinciding with the TO exists and each of CG configurations respectively corresponding to a plurality of coinciding TOs is included in the first CG configuration set and if the third field indicates that PUSCHs are simultaneously sent on a plurality of coinciding TOs, the first TO in the plurality of coinciding TOs according to the fourth field.

The case 3 and the foregoing case 2 are similar, and are different in that indications of third fields are different. Another example is used for description herein. Refer to FIG. 11. for example, for TO1 thereof, currently, there is another TO (that is, TO3) that coincides with TO1, a CG configuration corresponding to TO1 is the CG configuration 1, a CG configuration corresponding to TO3 is the CG configuration 2, and the two CG configurations are both included in the first CG configuration set. Therefore, it first indicates that such two TOs as TO1 and TO3 are both qualified to send the first indication information.

However, when TOs coincide, further refer to an indication of the third field. If the third field indicates that PUSCHs are simultaneously sent on a plurality of coinciding TOs, that is, PUSCHs can be simultaneously sent on TO1 and TO3, it indicates that each of the two coinciding TOs is qualified to send the first indication information.

In this case, determining needs to be further performed according to the fourth field:

In an implementation, if the fourth field indicates that each of the plurality of simultaneously sent PUSCHs carries the first indication information, each of the plurality of coinciding TOs is determined as the first TO.

For example, in the current example, PUSCHs may be simultaneously sent on TO1 and TO3 that coincide, and the fourth field indicates that each of the simultaneously sent PUSCHs carries the first indication information. That is, the PUSCH sent on TO1 carries the first indication information, and the PUSCH sent on TO3 also carries the same first indication information. Therefore, each of TO1 and TO3 is determined as the first TO.

In another implementation, if the fourth field indicates that none of the plurality of simultaneously sent PUSCHs carries the first indication information, a target TO of the plurality of coinciding TOs is determined as the first TO.

For example, in the current example, PUSCHs may be simultaneously sent on TO1 and TO3 that coincide, but the fourth field indicates that none of the simultaneously sent PUSCHs can carry the first indication information. In this case, a specific TO on which a PUSCH carrying the first indication information is sent needs to be determined. That is, one first TO still needs to be selected from TO1 and TO3 that coincide.

For example, a target TO in the plurality of coinciding TOs may be determined as the first TO. The target TO is a TO corresponding to a predefined CG configuration in the plurality of coinciding TOs.

The predefined CG configuration may be a first CG configuration in the first CG configuration set. Assuming that the first CG configuration set is {cg1, cg2}, the predefined CG configuration (the first one) is the CG configuration 1. in the current example, in TO1 and TO3 that coincide, a TO corresponding to the CG configuration 1 is TO1, that is, TO1 is the target TO. Therefore, TO1 may be determined as the first TO for sending the first indication information.

Alternatively, the predefined CG configuration may be a CG configuration having a smallest sequence number in the first CG configuration set. Assuming that the first CG configuration set is {cg2, cg1}, the predefined CG configuration (whose sequence number is the smallest) is the CG configuration 1. in the current example, in TO1 and TO3 that coincide, a TO corresponding to the CG configuration 1 is TO1, that is, TO1 is the target TO. Therefore, TO1 may be determined as the first TO for sending the first indication information.

The foregoing describes, with reference to FIG. 11, a case of determining whether a TO is a first TO in various possible cases. Determining is performed sequentially for a plurality of TOs in the first reporting period, to determine at least one first TO. In addition, it should be further noted that, in this embodiment, the first TO is used for sending the first indication information based on one premise that the first TO is a TO to be used by the terminal device, that is, a used TO.

It should be further noted that, for the first TO in the first reporting period, if there is a TO coinciding with the first TO, the first TO and the TO coinciding therewith are jointly referred to as a plurality of initially coinciding TOs herein. If only one TO in the plurality of initially coinciding TOs includes sending of a PUSCH of UTO-UCI, because no UTO-UCI indicates a TO usage status in a current reporting period, the network device cannot determine which one of the plurality of initially coinciding TOs is specifically a used TO. Therefore, the network device may perform blind detection on the plurality of initially coinciding TOs, and therefore it can be ensured that UTO-UCI is effectively received.

Therefore, in this embodiment, in various possible TO distribution cases caused by existence of the plurality of sets of CG configurations, the first TO used to send the first indication information can be correctly and effectively determined by using each field in the first signaling.

There is still a problem 3 to be resolved for reporting of indication information of a plurality of CG configurations listed above. That is, how to encode the sent UTO-UCI for usage statuses of a plurality of TOs within a period.

First, it should be noted that, the first indication information is used to report a TO usage status of each CG configuration included in the second CG set in the first reporting period. Each TO of TOs that meet the condition herein and whose usage statuses need TO be reported corresponds to one bit. When a bit corresponding to a TO is 1, it indicates that the TO is an unused TO; and when a bit corresponding to a TO is 0, it indicates that the TO is a used TO.

Therefore, the first indication information includes bits of TOs that correspond to CG configurations in the second CG configuration set and that are included in the first reporting period, and the bits are used to indicate whether the terminal device uses the corresponding TOs.

In the foregoing example, it is assumed that the second CG configuration set is {cg1, cg2, cg3}, that is, the UE reports only the usage statuses of the TO indicated by the CG configuration 1, the TO indicated by the CG configuration 2, and the TO indicated by the CG configuration 2 in the first reporting period.

Then, with reference to FIG. 11, actually, the first reporting period further includes TO9 indicated by the CG configuration 4. However, because the CG configuration 4 is not included in the second CG configuration set, the UE does not report the usage status of TO9.

In addition, it should be further noted that, the second CG configuration set includes a CG configuration whose TO usage status needs to be reported by the UE. However, because there are a plurality of possible implementations of a reporting period, it cannot be ensured that a TO of each CG configuration in the second CG configuration set is necessarily included in each reporting period. Therefore, the UE reports only a TO usage status, included in the first reporting period, of each CG configuration included in the second CG configuration set.

For example, it is assumed that the second CG configuration set is {cg1, cg2, cg3}. However, currently, only a TO of the CG configuration 1 and a TO of the CG configuration 2 exist in a reporting period, and then correspondingly, the first reported information includes only usage statuses of the TO of the CG configuration 1 and the TO of the CG configuration 2. In addition, the network device can learn a specific configuration status of each TO in each reporting period. Therefore, for the current example, the network device side can determine that the reporting period does not include a TO of the CG configuration 3. Therefore, during decoding, the usage status of each TO in the reporting period can be correctly obtained provided that the processing is performed according to an encoding/decoding manner agreed on with the UE.

The foregoing describes only a case in which respective corresponding bits exist for corresponding TOs in the first reporting period, thereby forming the first indication information. However, final code can be obtained only after how to specifically sort the bits respectively corresponding to the plurality of TOs is determined.

In a possible implementation, an arrangement order of the bits is: sorting is performed according to a chronological order of the TOs; and then sorting is performed for a plurality of chronologically coinciding TOs according to an order of corresponding CG configurations in the second CG configuration set.

For example, understanding may be performed with reference to FIG. 11. Similarly, the first reporting period is used as an example. Assuming that the second CG configuration set is {cg1, cg2, cg3}, the UE needs to report only TO usage statuses corresponding to the CG configuration 1, the CG configuration 2, and the CG configuration 3, that is, the UE reports only usage statuses of TO1 to TO8. Assuming that each of TO5, TO6, and TO8 thereof is an unused TO, bits corresponding to the three TOs are 1, and bits corresponding to the remaining five TOs are 0.

According TO a current bit sorting manner, TO1 and TO3 are chronologically foremost and coincide. Therefore, sorting is performed in an order of CG configurations corresponding to the two TOs in the second CG configuration set. TO1 corresponds to the CG configuration 1, and TO3 corresponds to the CG configuration 2. In the second CG configuration set, the CG configuration 1 is in the front, and the CG configuration 2 is at the back. Then, referring to the first type of UTO-UCI shown in FIG. 11, a bit (0) of TO1 is the first bit, and a bit (1) of TO3 is the second bit.

In addition, according to the chronological order of TOs, the third bit is a bit (0) of TO4.

Moreover, according to the chronological order of TOs, TO2 and TOS that coincide follow behind. According to an implementation the same as the foregoing implementation, it may be determined that the CG configuration 1 corresponding to TO2 is ranked top. Therefore, the fourth bit is a bit (0) of TO2, and the fifth bit is a bit (1) of TO5.

Then, according to the chronological order of the TOs, the sixth bit is a bit (0) of TO7, the seventh bit is a bit (1) of TO6, and the eighth bit is a bit (1) of TO8.

Therefore, according to the foregoing sorting manner, it may be learned that the UTO-UCI is 00001011 shown in FIG. 11.

In another possible implementation, sorting may alternatively be performed according to an order of the CG configurations in the second CG configuration set; and then sorting is performed for the TOs corresponding to all the CG configurations according to a chronological order of the TOs.

Similarly, FIG. 11 is used as an example. Assuming that the second CG configuration set is {cg1, cg2, cg3}, according to an order of CG configurations in the first reporting period in the second CG configuration set, it may be determined that bits of TOs in the CG configuration 1 (TO1 and TO2) are first arranged, bits of TOs in the CG configuration 2 (TO3, TO4, TO5, and TO6) are then arranged, and bits of TOs in the CG configuration 3 (TO7 and TO8) are then arranged.

Then, sorting is performed for the TOs corresponding to all the CG configurations according to a chronological order of the TOs.

For example, for the TOs (TO1 and TO2) of the CG configuration 1, the bit of TO1 is first arranged, and then the bit of TO2 is arranged according to the chronological order of the TOs, to obtain first two bits 00 in the UTO-UCI.

In addition, for the TOs (TO3, TO4, TO5, and TO6) in the CG configuration 2, the bits of TO3, TO4, TO5, and TO6 are sequentially arranged according to the chronological order of the TOs, to obtain the third to sixth bits 0011 in the UTO-UCI.

Moreover, for the TOs (TO7 and TO8) in the CG configuration 3, the bit of TO7 is first arranged, and then the bit of TO8 is arranged according to the chronological order of the TOs, to obtain last two bits 01 in the UTO-UCI.

Therefore, according to the foregoing sorting manner, it may be learned that the UTO-UCI is 00001101 shown in FIG. 11.

In an example of FIG. 11, assuming that TO1, TO4, and TO2 are determined as first TOs, the UTO-UCI is sent on each of the three TOs. Content of the UTO-UCI sent on the three TOs may be the same, and may each include the code content described above.

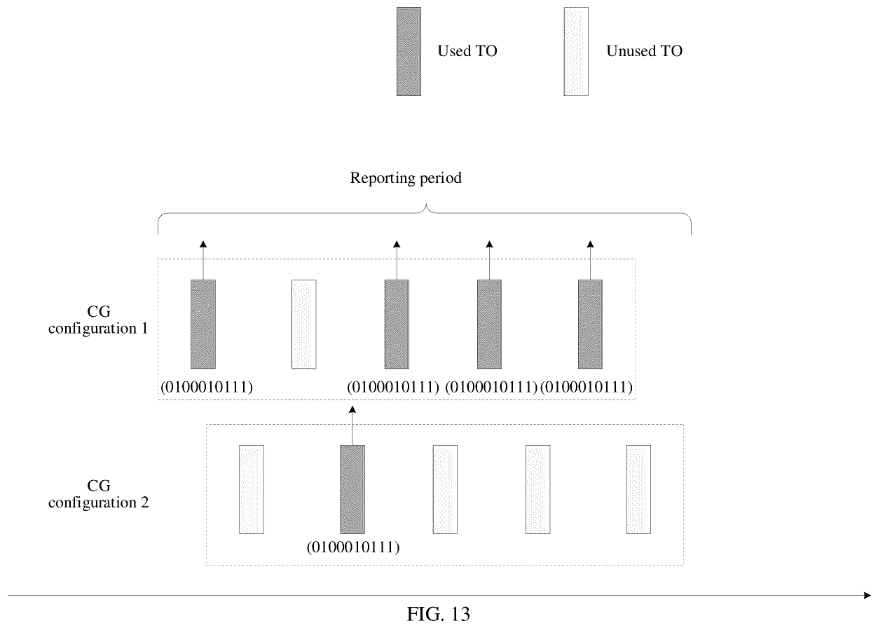

Because the exemplary case in FIG. 11 is relatively complex, the foregoing two UTO-UCI coding manners of a plurality of CG configurations are further described below by using a clearer example with reference to FIG. 12 and FIG. 13. FIG. 12 is a first diagram of implementation of determining UTO-UCI according to an embodiment of this application. FIG. 13 is a second diagram of implementation of determining UTO-UCI according to an embodiment of this application.

First, the first sorting manner described above is described with reference to FIG. 12. That is, sorting is performed first according to a chronological order of TOs, and then coinciding TOs are sorted according to a corresponding CG configuration order.

As shown in FIG. 12, it is assumed that a first reporting period currently includes 10 TOs, which are respectively five TOs corresponding to a CG configuration 1 and five TOs corresponding to a CG configuration 2. It is assumed that in the five TOs corresponding to the CG configuration 1, the 2^{nd} TO is an unused TO (unused TO), and the rest are used TOs (used TOs). In addition, it is assumed that in the five TOs corresponding to the CG configuration 2, the 2^{nd} TO is a used TO (used TO), and the rest are unused TOs (unused TOs).

Then, sorting is performed according to a chronological order of the TOs. It may be determined with reference to FIG. 12 that, the five TOs corresponding to the CG configuration 1 and the five TOs corresponding to the CG configuration 2 are sequentially alternated. Then, the sorting sequence is a bit of the 1^{st} TO of the CG configuration 1, a bit of the 1^{st} TO of the CG configuration 2, a bit of the 2^{nd} TO of the CG configuration 1, a bit of the 2^{nd} TO of the CG configuration 2, and so on. In this way, UTO-UCI: 0110010101 shown in FIG. 12 is obtained.

Next, the second sorting manner described above is described with reference to FIG. 13. That is, sorting is first performed according to an order of CG configurations, and then, a plurality of TOs of each CG configuration are sorted according to a chronological order of TOs.

A case of a TO in a first reporting period in FIG. 13 is similar to that described above. Therefore, sorting is performed according to an order of CG configurations. For example, the five TOs of the CG configuration 1 are followed by the five TOs of the CG configuration 2. Corresponding bits of the five TOs of the CG configuration 1 are 01000 in sequence according to the chronological order of the TOs, and corresponding bits of the five TOs of the CG configuration 2 are 10111 in sequence according to the chronological order of the TOs, thereby obtaining UTO-UCI: 0100010111 shown in FIG. 13.

Therefore, according to the technical solution provided in this application, a problem of encoding UTO-UCI of a plurality of CG configurations can also be effectively resolved, and based on the foregoing content, as long as the UE and the network side agree on an encoding/decoding manner, any possible manner can be extended to encode UTO-UCI of a plurality of CG configurations.

The foregoing embodiments describe related implementation on the terminal device side. On the network device side, first signaling may be sent to the terminal device, and the network device may also determine a first TO in a plurality of TOs in a first reporting period according to the first signaling, and then receive first indication information on the first TO. Related implementation on the network device side is similar to that on the terminal device side described in the foregoing embodiments, and details are not described herein again.

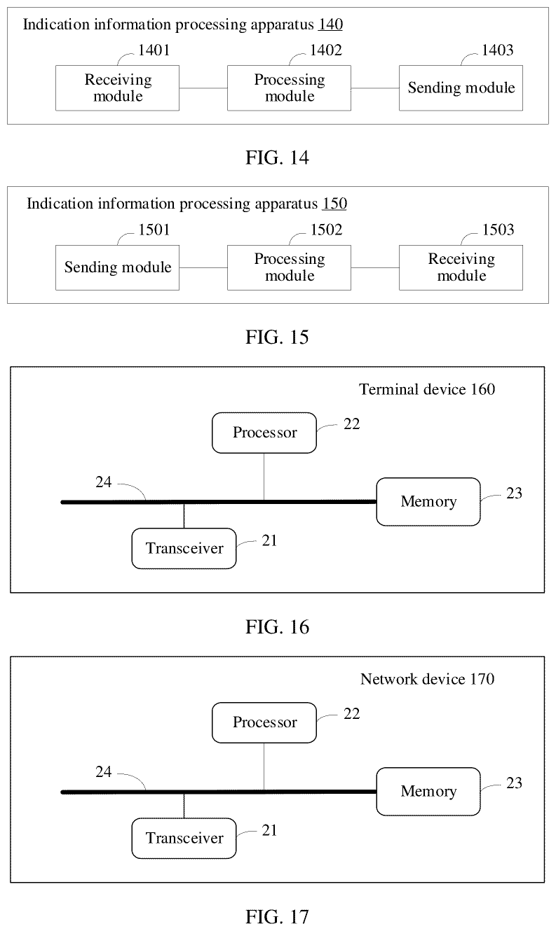

FIG. 14 is a first diagram of a structure of an indication information processing apparatus according to an embodiment of this application. As shown in FIG. 14, the apparatus 140 includes: a receiving module 1401, a processing module 1402, and a sending module 1403.

The receiving module 1401 is configured to receive first signaling sent by a network device;
the processing module 1402 is configured to determine a first TO in a plurality of transmission occasions TOs in a first reporting period according to the first signaling, where the plurality of TOs are indicated by at least two sets of configured grant CG configurations; and
the sending module 1403 is configured to send first indication information on the first TO, where the first indication information is used to indicate a TO usage status in the first reporting period.

In a possible design, the first signaling includes a first field, and the first field is used to indicate a first CG configuration set allowed to send the first indication information.

In a possible design, the first signaling further includes a second field, the second field is used to indicate a second CG configuration set, and the first indication information is used to indicate a TO usage status of the second CG configuration set in a reporting period.

In a possible design, the first signaling further includes a third field, and the third field is used to indicate whether physical uplink shared channels PUSCHs are simultaneously sent on a plurality of coinciding TOs.

In a possible design, the first signaling further includes a fourth field, and the fourth field is used TO indicate, when PUSCHs are simultaneously sent on a plurality of coinciding TOs, whether each of the plurality of simultaneously sent PUSCHs carries the first indication information.

In a possible design, the processing module 1402 is specifically configured to:
determine, for any TO in the plurality of TOs, the TO as the first TO if no TO coinciding with the TO exists and a CG configuration corresponding to the TO is included in the first CG configuration set.

In a possible design, the processing module 1402 is specifically configured to:
determine, for any TO in the plurality of TOs if another TO coinciding with the TO exists and each of CG configurations respectively corresponding to a plurality of coinciding TOs is included in the first CG configuration set, the first TO in the plurality of coinciding TOs according to the third field.

In a possible design, the processing module 1402 is specifically configured to:
determine, if the third field indicates that PUSCHs are not simultaneously sent on a plurality of coinciding TOs, a TO indicated as a to-be-used TO in the plurality of coinciding TOs as the first TO; or
determine, if the third field indicates that PUSCHs are simultaneously sent on a plurality of coinciding TOs, the first TO in the plurality of coinciding TOs according to the fourth field.

In a possible design, the processing module 1402 is specifically configured to:
determine, if the fourth field indicates that each of the plurality of simultaneously sent PUSCHs carries the first indication information, each of the plurality of coinciding TOs as the first TO; or
determine, if the fourth field indicates that none of the plurality of simultaneously sent PUSCHs carries the first indication information, a target TO of the plurality of coinciding TOs as the first TO.

In a possible design, the target TO is a TO corresponding to a predefined CG configuration in the plurality of coinciding TOs.

In a possible design, the predefined CG configuration is a first CG configuration in the first CG configuration set; or
the predefined CG configuration is a CG configuration having a smallest sequence number in the first CG configuration set.

In a possible design, the first indication information includes bits of TOs corresponding to CG configurations in the second CG configuration set in the first reporting period, and the bits are used to indicate whether the terminal device uses the corresponding TOs.

In a possible design, an arrangement order of the bits is: sorting is performed according to a chronological order of the TOs; and then sorting is performed for a plurality of chronologically coinciding TOs according to an order of corresponding CG configurations in the second CG configuration set.

In a possible design, an arrangement order of the bits is: sorting is performed according to an order of the CG configurations in the second CG configuration set; and then sorting is performed for the TOs corresponding to all the CG configurations according to a chronological order of the TOs.

In a possible design, the first signaling is radio resource control RRC signaling.

In a possible design, the first indication information is uplink control information UCI.

The apparatus provided in this embodiment may be configured to execute the technical solutions of the foregoing method embodiments. The implementation principles and technical effects thereof are similar, and details are not described again in this embodiment.

FIG. 15 is a second diagram of a structure of an indication information processing apparatus according to an embodiment of this application. As shown in FIG. 15, the apparatus 150 includes: a sending module 1501, a processing module 1502, and a receiving module 1503.

The sending module 1501 is configured to send first signaling to a terminal device;
the processing module 1502 is configured to determine a first TO in a plurality of TOs in a first reporting period according to the first signaling, where the plurality of TOs are indicated by at least two sets of CG configurations; and
the receiving module 1503 is configured to receive first indication information on the first TO, where the first indication information is used to indicate a TO usage status in the first reporting period.

In a possible design, the first signaling includes a first field, and the first field is used to indicate a first CG configuration set allowed to send the first indication information.

In a possible design, the first signaling further includes a second field, the second field is used to indicate a second CG configuration set, and the first indication information is used to indicate a TO usage status of the second CG configuration set in a reporting period.

In a possible design, the first signaling further includes a third field, and the third field is used to indicate whether PUSCHs are simultaneously sent on a plurality of coinciding TOs.

In a possible design, the first signaling further includes a fourth field, and the fourth field is used TO indicate, when PUSCHs are simultaneously sent on a plurality of coinciding TOs, whether each of the plurality of simultaneously sent PUSCHs carries the first indication information.

In a possible design, the processing module 1502 is specifically configured to:
determine, for any TO in the plurality of TOs, the TO as the first TO if no TO coinciding with the TO exists and a CG configuration corresponding to the TO is included in the first CG configuration set.

In a possible design, the processing module 1502 is specifically configured to:
determine, for any TO in the plurality of TOs if another TO coinciding with the TO exists and each of CG configurations respectively corresponding to a plurality of coinciding TOs is included in the first CG configuration set, the first TO in the plurality of coinciding TOs according to the third field.

In a possible design, the processing module 1502 is specifically configured to:
determine, if the third field indicates that PUSCHs are not simultaneously sent on a plurality of coinciding TOs, a TO indicated as a to-be-used TO in the plurality of coinciding TOs as the first TO; or
determine, if the third field indicates that PUSCHs are simultaneously sent on a plurality of coinciding TOs, the first TO in the plurality of coinciding TOs according to the fourth field.

In a possible design, the processing module 1502 is specifically configured to:
determine, if the fourth field indicates that each of the plurality of simultaneously sent PUSCHs carries the first indication information, each of the plurality of coinciding TOs as the first TO; or
determine, if the fourth field indicates that none of the plurality of simultaneously sent PUSCHs carries the first indication information, a target TO of the plurality of coinciding TOs as the first TO.

In a possible design, the target TO is a TO corresponding to a predefined CG configuration in the plurality of coinciding TOs.

In a possible design, the predefined CG configuration is a first CG configuration in the first CG configuration set; or
the predefined CG configuration is a CG configuration having a smallest sequence number in the first CG configuration set.

In a possible design, the first indication information includes bits of TOs corresponding to CG configurations in the second CG configuration set in the first reporting period, and the bits are used to indicate whether the terminal device uses the corresponding TOs.

In a possible design, an arrangement order of the bits is: sorting is performed according to a chronological order of the TOs; and then sorting is performed for a plurality of chronologically coinciding TOs according to an order of corresponding CG configurations in the second CG configuration set.

In a possible design, an arrangement order of the bits is: sorting is performed according to an order of the CG configurations in the second CG configuration set; and then sorting is performed for the TOs corresponding to all the CG configurations according to a chronological order of the TOs.

In a possible design, the first signaling is RRC signaling.

In a possible design, the first indication information is UCI.

The apparatus provided in this embodiment may be configured to execute the technical solutions of the foregoing method embodiments. The implementation principles and technical effects thereof are similar, and details are not described again in this embodiment.

The indication information processing method provided in embodiments of this application may be applied to an electronic device having a communication function. The electronic device includes a terminal device. For a specific device form and the like of the terminal device, refer to the foregoing related descriptions. Details are not described herein again.

FIG. 16 is a diagram of a structure of a terminal device according to an embodiment of this application. Referring to FIG. 16, a terminal device 160 may include: a transceiver 21, a memory 22, and a processor 23. The transceiver 21 may include: a transmitter and/or a receiver. The transmitter may also be referred to as a similar description such as a sender, a sending set, a sending port, or a sending interface. The receiver may also be referred to as a similar description such as a receiver, a receiving set, a receiving port, or a receiving interface. For example, the transceiver 21, the memory 22, and the processor 23 are connected to each other through a bus 24.

The memory 22 is configured to store a program instruction. The processor 23 is configured to execute the program instruction stored in the memory, so as to enable the terminal device 120 to perform the configuration method for a multicast service in any one of the foregoing embodiments. A receiver of the transceiver 21 may be configured to perform a receiving function of the terminal device in the foregoing configuration method for a multicast service.

FIG. 17 is a diagram of a structure of a network device according to an embodiment of this application. Referring to FIG. 17, a network device 170 may include: a transceiver 31, a memory 32, and a processor 33. The transceiver 31 may include: a transmitter and/or a receiver. The transmitter may also be referred to as a similar description such as a sender, a sending set, a sending port, or a sending interface. The receiver may also be referred to as a similar description such as a receiver, a receiving set, a receiving port, or a receiving interface. For example, the transceiver 31, the memory 32, and the processor 33 are connected to each other through a bus 34.

The memory 32 is configured to store a program instruction. The processor 33 is configured to execute the program instruction stored in the memory, so as to enable the network device 130 to perform the configuration method for a multicast service in any one of the foregoing embodiments. A receiver of the transceiver 31 may be configured to perform a receiving function of the network device in the foregoing configuration method for a multicast service.

An embodiment of this application provides a chip. The chip includes a processor, and the processor is configured to invoke a computer program in a memory to execute the technical solutions in the foregoing embodiments. The implementation is similar to the foregoing related embodiments in terms of implementation principles and technical effects. Details are not described herein again.

An embodiment of this application further provides a computer-readable storage medium. The computer-readable storage medium stores computer program instructions. The computer program is executed by a processor to implement the foregoing methods. All or some of the methods described in the foregoing embodiments may be implemented through software, hardware, firmware, or any combination thereof. If the methods are implemented through the software, a function may be stored on the computer-readable medium as one or more instructions or code or transmitted on the computer-readable medium. The computer-readable medium may include a computer storage medium and communication medium, and may also include any medium that can transfer a computer program from one place to another. The storage medium may be any target medium accessible by a computer.

In a possible implementation, the computer-readable medium may include a RAM, a ROM, a compact disc read-only memory (compact disc read-only memory, CD-ROM) or another optical disc memory, a magnetic disk memory or another magnetic storage device, or any other medium that is intended to carry or store required program code in a form of instruction or data structure, and may be accessed by the computer. In addition, any connection is appropriately referred to as a computer-readable medium. For example, if a coaxial cable, an optical fiber cable, a twisted pair, a digital subscriber line (Digital Subscriber Line, DSL), or a wireless technology (like infrared, radio, and a microwave) is used to transmit software from a website, a server, or another remote source, the coaxial cable, the optical fiber cable, the twisted pair, the DSL, or the wireless technology such as infrared, radio, and a microwave is included in a definition of the medium. A disk and an optical disc as used in this specification include an optical disc, a laser disk, a digital versatile disc (Digital Versatile Disc, DVD), a floppy disk, and a blue-ray disc, where the disk generally reproduces data by magnetic means, while the optical disc optically reproduces data by using a laser. A combination of the foregoing should also be included in the scope of the computer-readable medium.

An embodiment of this application provides a computer program product. The computer program product includes a computer program, and when the computer program is run, a computer is enabled to perform the foregoing methods.

Embodiments of this application are described with reference to the flowcharts and/or block diagrams of the method, the device (system), and the computer program product according to embodiments of this application. It should be understood that computer program instructions may be used to implement each procedure and/or each block in the flowcharts and/or the block diagrams and a combination of procedures and/or blocks in the flowcharts and/or the block diagrams. These computer program instructions may be provided to a general-purpose computer, a special-purpose computer, an embedded processor, or a processing unit of another programmable device to generate a machine, so that the instructions executed by the computer or the processing unit of the another programmable data processing device generate an apparatus for implementing a specific function in one or more procedures in the flowcharts and/or in one or more blocks in the block diagrams.

The objectives, technical solutions, and beneficial effects of the present invention are further described in detail in the foregoing specific implementations. It should be understood that the foregoing descriptions are merely specific implementations of the present invention, but are not intended to limit the protection scope of the present invention. Any modification, equivalent replacement, or improvement made based on the technical solutions of the present invention shall fall within the protection scope of the present invention.

What is claimed is:

1. An indication information processing method, applied to a terminal device, wherein the method comprises:
receiving first signaling sent by a network device;
determining a first TO in a plurality of transmission occasions TOs in a first reporting period according to the first signaling, wherein the plurality of TOs are indicated by at least two sets of configured grant CG configurations; and
sending first indication information on the first TO, wherein the first indication information is used to indicate a TO usage status in the first reporting period.

2. The method according to claim 1, wherein the first signaling comprises a first field, and the first field is used to indicate a first CG configuration set allowed to send the first indication information.

3. The method according to claim 1, wherein the first signaling further comprises a second field, the second field is used to indicate a second CG configuration set, and the first indication information is used to indicate a TO usage status of the second CG configuration set in a reporting period.

4. The method according to claim 1, wherein the first signaling further comprises a third field, and the third field is used to indicate whether physical uplink shared channels, PUSCHs are simultaneously sent on a plurality of coinciding TOs.

5. The method according to claim 1, wherein the first signaling further comprises a fourth field, and the fourth field is used TO indicate, when PUSCHs are simultaneously sent on a plurality of coinciding TOs, whether each of the plurality of simultaneously sent PUSCHs carries the first indication information.

6. The method according to claim 1, wherein the determining a first TO in a plurality of TOs in a first reporting period according to the first signaling comprises:
determining, for any TO in the plurality of TOs, the TO as the first TO if no TO coinciding with the TO exists and a CG configuration corresponding to the TO is comprised in the first CG configuration set.

7. The method according to claim 1, wherein the determining a first TO in a plurality of TOs in a first reporting period according to the first signaling comprises:
determining, for any TO in the plurality of TOs if another TO coinciding with the TO exists and each of CG configurations respectively corresponding to a plurality of coinciding TOs is comprised in the first CG configuration set, the first TO in the plurality of coinciding TOs according to the third field.

8. The method according to claim 7, wherein the determining the first TO in the plurality of coinciding TOs according to the third field comprises:
determining, if the third field indicates that PUSCHs are not simultaneously sent on a plurality of coinciding TOs, a TO indicated as a to-be-used TO in the plurality of coinciding TOs as the first TO; or
determining, if the third field indicates that PUSCHs are simultaneously sent on a plurality of coinciding TOs, the first TO in the plurality of coinciding TOs according to the fourth field.

9. The method according to claim 8, wherein the determining the first TO in the plurality of coinciding TOs according to the fourth field comprises:
determining, if the fourth field indicates that each of the plurality of simultaneously sent PUSCHs carries the first indication information, each of the plurality of coinciding TOs as the first TO; or
determining, if the fourth field indicates that none of the plurality of simultaneously sent PUSCHs carries the first indication information, a target TO of the plurality of coinciding TOs as the first TO.

10. The method according to claim 9, wherein the target TO is a TO corresponding to a predefined CG configuration in the plurality of coinciding TOs.

11. The method according to claim 10, wherein the predefined CG configuration is a first CG configuration in the first CG configuration set; or
the predefined CG configuration is a CG configuration having a smallest sequence number in the first CG configuration set.

12. The method according to claim 3, wherein the first indication information comprises bits of TOs corresponding to CG configurations in the second CG configuration set in the first reporting period, and the bits are used to indicate whether the terminal device uses the corresponding TOs.

13. The method according to claim 12, wherein an arrangement order of the bits is: sorting is performed according to a chronological order of the TOs; and then sorting is performed for a plurality of chronologically coinciding TOs according to an order of corresponding CG configurations in the second CG configuration set.

14. The method according to claim 12, wherein an arrangement order of the bits is: sorting is performed according to an order of the CG configurations in the second CG configuration set; and then sorting is performed for the TOs corresponding to all the CG configurations according to a chronological order of the TOs.

15. The method according to claim 1, wherein the first signaling is radio resource control RRC signaling.

16. The method according to claim 1, wherein the first indication information is uplink control information UCI.

17. An indication information processing method, applied to a network device, wherein the method comprises:
sending first signaling to a terminal device;
determining a first TO in a plurality of TOs in a first reporting period according to the first signaling, wherein the plurality of TOs are indicated by at least two sets of CG configurations; and
receiving first indication information on the first TO, wherein the first indication information is used to indicate a TO usage status in the first reporting period.

18. The method according to claim 17, wherein the first signaling comprises a first field, and the first field is used to indicate a first CG configuration set allowed to send the first indication information.

19. The method according to claim 17, wherein the first signaling further comprises a second field, the second field is used to indicate a second CG configuration set, and the first indication information is used to indicate a TO usage status of the second CG configuration set in a reporting period.

20. A terminal device, comprising: a processor and a memory, wherein
the memory stores computer-executable instructions; and
the processor executes the computer-executable instructions stored in the memory, to enable the terminal device to
receive first signaling sent by a network device;
determine a first TO in a plurality of transmission occasions TOs in a first reporting period according to the first signaling, wherein the plurality of TOs are indicated by at least two sets of configured grant CG configurations; and
send first indication information on the first TO, wherein the first indication information is used to indicate a TO usage status in the first reporting period.
